(19) United States
(12) Patent Application Publication
(10) Pub. No.: US 2025/0368231 A1
(43) Pub. Date: Dec. 4, 2025

(54) Method for Predicting a State of an Environment of a Vehicle

(71) Applicant: Robert Bosch GmbH, Stuttgart (DE)

(72) Inventors: Johannes Christian Mueller, Stuttgart (DE); Max Keller, Korntal-Muenchingen (DE)

(21) Appl. No.: 19/219,408

(22) Filed: May 27, 2025

(30) Foreign Application Priority Data
May 28, 2024 (DE) 10 2024 204 944.1

(51) Int. Cl. B60W 60/00; B60W 50/00; G06N 3/09

(52) U.S. Cl. CPC B60W 60/0027; B60W 50/0097; G06N 3/09; B60W 2554/4041; B60W 2556/40

(57) ABSTRACT

A method for predicting a state of an environment of a vehicle includes determining an occupancy grid, a digital map, and a list of objects. The method further includes encoding the occupancy grid to a first occupancy grid representation in a latent space for the occupancy grid, the digital map to a first map representation in a latent space for the digital map, and the list of objects to a first object list representation in a latent space for the list of objects. The method further includes predicting, for each of one or more future points in time of the environment of the vehicle, a respective further occupancy grid representation, a respective further map representation, and a respective object list representation.

This application claims priority under 35 U.S.C. § 119 to patent application no. DE 10 2024 204 944.1, filed on May 28, 2024 in Germany, the disclosure of which is incorporated herein by reference in its entirety.

The disclosure relates to methods of predicting a state of a vehicle's environment.

### BACKGROUND

In the area of autonomous systems, predicting the behavior of moving objects in the vicinity of a controlled agent (such as a vehicle) is an important task in order to reliably control the agent and to avoid collisions, for example.

For example, an autonomous vehicle must be capable of anticipating the future development of a travel situation, which in particular includes the behavior of other vehicles in the vicinity of the autonomous vehicle, in order to enable performant and safe automated driving. Determining a control of the autonomous vehicle, e.g., represented by a future trajectory to be followed by the autonomous vehicle, therefore must include the behavior of other vehicles. The vehicles to be taken into account for the autonomous vehicle (ego vehicle) are also called target vehicles.

Accordingly, reliable approaches to predict future states of ego vehicles' environments are desirable.

### SUMMARY

According to various embodiments, a method for predicting a state of a vehicle's environment is provided, comprising determining an occupancy grid of the vehicle's environment for a current state of the vehicle's environment; a digital map for the current state of the vehicle's environment; and a list of objects present in the environment of the vehicle in the current state of the vehicle's environment. Encoding the occupancy grid to a first occupancy grid representation in a latent space for the occupancy grid, the digital map to a first map representation in a latent space for the digital map, and the list of objects to a first object list representation in a latent space for the list of objects. Predicting, for each of one or more points in time of future states of the vehicle's environment, a respective further occupancy grid representation in the latent space for the occupancy grid, a respective further map representation in the latent space for the map representations, and a respective object list representation in the latent space for the list of objects. Wherein, for each of the one or more points in time, the further occupancy grid representation is predicted prior to predicting the further map representation and predicting the further object list representation and is used for predicting the further map representation and predicting the further object list representation.

The method described above allows for a reliable prediction of future states as the prediction of the map representation and the prediction of the object list representation benefit from the occupancy grid prediction (previously performed for the given time increment): For example, navigable and non-navigable space may be identified by the occupancy grid, and this information may be considered by, and thereby improve, map prediction and object list prediction (in the latent space).

Various exemplary embodiments are specified in the following.

Exemplary embodiment 1 is a method for predicting a state of the environment of an (ego) vehicle, as described above.

Exemplary embodiment 2 is the method according to exemplary embodiment 1, wherein, for each of the one or more points in time, the further map representation is predicted prior to predicting the further object list representation and is used for predicting the further object list representation.

The object list prediction benefits from the previously predicted map, for example, because traffic rules are identifiable using the map.

Exemplary embodiment 3 is the method according to exemplary embodiment 1 or 2, further comprising determining a visibility grid for the current state of the environment of the vehicle, encoding the visibility grid to a first visibility grid representation in a latent space for the visibility grid, predicting a respective further visibility grid representation for each of the one or more points in time, wherein, for each of the one or more points in time, the further occupancy grid representation is predicted prior to predicting the further visibility grid representation and is used for predicting the further visibility grid representation, and the further visibility grid representation is predicted prior to predicting the further map representation and is used for predicting the further map representation.

For example, the additional predicted visibility grid allows a safer behavior of the automated vehicle to be predicted (i.e., to be planned) as hazardous, non-visible areas may be explicitly considered.

Exemplary embodiment 4 is the method according to any one of the exemplary embodiments 1 to 3, further comprising planning a behavior of the (ego) vehicle for each of the one or more points in time by determining a respective behavior representation in a latent space for the behavior using the further occupancy grid representation predicted at the point in time, further map representation and further object list representation (as well as the predicted further visibility grid representation, if available).

It is thus possible to plan the behavior of the vehicle, which may also be considered to be “predicting” a behavior of the vehicle, along with determining the other predictions (also using the prediction for the further visibility grid representation, if available) in the latent space. This enables flexible and reliable planning to be carried out.

Exemplary embodiment 5 is the method according to any one of exemplary embodiments 1 to 4, comprising predicting the further occupancy grid representation by means of a neural occupancy grid predictive network, the further map representation by means of a neural map predictive network and the object list representation by means of a neural object list predictive network (as well as, if available, the further visibility grid representation by means of a neural visibility grid predictive network and/or the behavior of the vehicle by means of a neural behavior predictive network), and training the neural occupancy grid prediction network, the neural map predictive network and the neural object list predictive network (and, if applicable, the neural visibility grid predictive network and/or the neural behavior predictive network), by determining occupancy grid costs by decoding the further occupancy grid representation to a respective further occupancy grid and comparing it to ground truth information for the occupancy grid for the respective point in time and/or by encoding the ground truth information for the occupancy grid for the respective point in time to an occupancy grid ground truth and comparing it with the further occupancy grid representation, by determining map costs by decoding the further map representation to a respective further digital map and comparing it to a ground truth information for the digital map for the respective point in time and/or by encoding the ground truth information for the digital map for the respective point in time to a map ground truth and comparing it to the further map representation, and/or by determining object list costs by decoding the further object list representation to a respective further list of objects for the respective point in time and comparing it with a ground truth information for the list of objects for the respective point in time and/or by encoding the ground truth information for the list of objects for the respective point in time to an object list ground truth and comparing it with the further object list representation.

Costs (i.e. “losses” according to the English term “loss”) may thus be calculated in the latent space or in “real” space. The neural predictive networks (also referred to herein as predictive networks) are adjusted to reduce costs (e.g., total costs including occupancy grid costs, map costs, and object list costs). Similarly, costs for the visibility grid and/or behavior planning may be considered (especially for training the predictive networks for the visibility grid or the behavior).

Exemplary embodiment 6 is the method for controlling a vehicle, comprising predicting a state of the environment of a vehicle according to one of exemplary embodiments 1-5 (or optionally directly planning the behavior of the vehicle) and controlling the vehicle depending on the predicted state (or the planned behavior).

Exemplary embodiment 7 is a vehicle control device which is set up to perform a method according to any of exemplary embodiments 1 to 6.

Exemplary embodiment 8 is a computer program with instructions that, when executed by a processor, cause the processor to carry out a method according to any of exemplary embodiments 1 to 7.

Exemplary embodiment 9 is a computer-readable medium that stores instructions that, when executed by a processor, cause the processor to perform a method according to any of exemplary embodiments 1 to 7.

### BRIEF DESCRIPTION OF THE DRAWINGS

In the drawings, similar reference signs generally refer to the same parts throughout the different views. The drawings are not necessarily to scale, wherein emphasis is instead generally placed on representing the principles of the disclosure. In the following description, various aspects are described with reference to the following drawings.

FIG. 1 shows a vehicle.

FIG. 2 illustrates a prediction model with factorization according to one embodiment.

FIG. 3 illustrates the training of the prediction model of FIG. 2 using additional encoders or decoders.

FIG. 4 shows a flowchart depicting a method for predicting a state of the environment of a vehicle according to one embodiment.

### DETAILED DESCRIPTION

The following detailed description relates to the accompanying drawings, which, for clarification, show specific details and aspects of this disclosure in which the disclosure may be implemented. Other aspects may be used, and structural, logical and electrical changes may be performed without departing from the scope of protection of the disclosure. The various aspects of this disclosure are not necessarily mutually exclusive since some aspects of this disclosure may be combined with one or a plurality of other aspects of this disclosure to form new aspects.

Different examples will be described in more detail in the following.

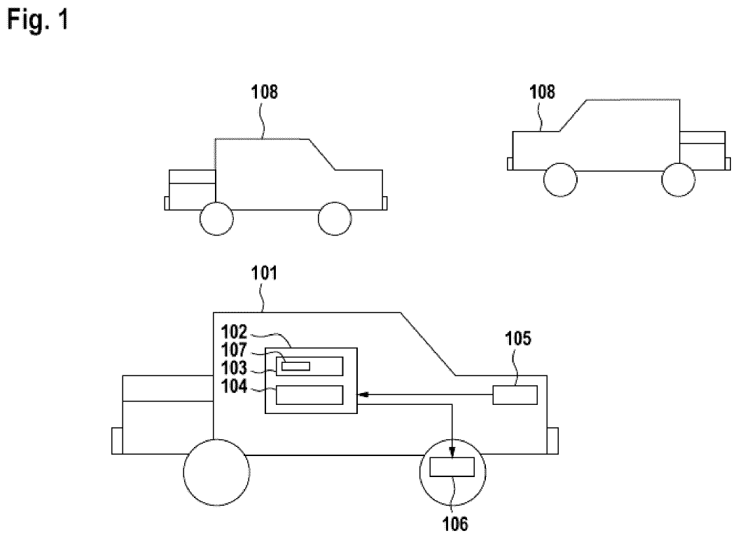

FIG. 1 shows a vehicle 101.

In the example of FIG. 1, a vehicle 101, for example a car or truck, is equipped with a vehicle control device 102.

The vehicle control device 102 has data processing components, e.g., a processor (e.g., a CPU (central processing unit)) 103 and a memory 104 for storing control software according to which the vehicle control device 102 operates, and data processed by the processor 103.

For example, the saved control software (computer program) has instructions that, when executed by the processor, cause the processor 103 to implement a machine learning (ML) model 107.

The data stored in the memory 104 may, for example, include image data captured by one or a plurality of cameras 105. For example, the one or the plurality of cameras 105 may take one or a plurality of grayscale photographs or color photographs of the surroundings of the vehicle 101. Using the image data (or also data from other sources of information, such as other types of sensors or also vehicle-to-vehicle communications), the vehicle control device 102 may detect objects in the surroundings of the vehicle 101, in particular other vehicles 108, and may determine their previous trajectories and thus capture a traffic scene.

The vehicle control device 102 may examine the sensor data and control the vehicle 101 according to the results, i.e., determine control actions for the vehicle and signal them to respective actuators of the vehicle. For example, the vehicle control device 102 may control an actuator 106 (e.g., a brake) in order to control the speed of the vehicle, e.g., to brake the vehicle.

The control device 102 must include the behavior of the further vehicles 108, i.e., their future trajectories, in determining a future trajectory 101 for the vehicle 101. The control device 102 must thus predict the (future) trajectories of the other vehicles 108 (generally “agents”), i.e., in other words traffic movements. The vehicle 101 for which the prediction is made (i.e., that is controlled based on the prediction, for example) is also hereinafter referred to as the ego vehicle. A vehicle 108 whose trajectory is predicted is hereinafter referred to as a target agent or target vehicle.

Predicting the movements of other road users (or other objects in the vicinity of the target vehicle) is a (substantial) part of predicting the environment of the ego vehicle.

The temporal projection of the current environment, i.e., the prediction, remains a major challenge on the path to automated driving. Only on the basis of accurate prediction may an automated driving function plan and drive logically and proactively. In recent years, deep learning approaches that make predictions based on experience learned from datasets have proven to be particularly promising. A common drawback of existing approaches is that they are often difficult to track. Furthermore, training a neural predictive network is often very challenging, depending on the dataset size and the scope of the prediction task.

A neural predictive network (or at least some of its layers (prediction components)) typically operates on a latent space, into which information about the current traffic situation (i.e., the current environment) is embedded in the form of embeddings (latent vectors) (by an encoder contained in the neural predictive network).

To achieve better interpretability and higher accuracy in predictive deep learning approaches, it has been shown that prediction models (e.g., neural predictive networks) that factorize the latent space are advantageous.

By factorizing in the latent space, training of the predictive model is simpler, as the task to learn is broken down into less complex subtasks. This allows for specialization of encoder and prediction components for subtasks. Interpretability of the predictive model's output improves, as access is provided to intermediate results, which may be translated using corresponding decoders into natural representations that may be interpreted by humans. It is possible to condition the output of one layer of a predictive component on the previously determined intermediate results of other predictive components of the same layer. Thus, for example, the prediction of the latent features of one scene representation in layer t1 may be based on previously predicted other latent features of the layer t1, which in turn leads to improved prediction and approaches human hierarchical thought processes.

According to various embodiments, a specific partitioning, i.e., factorization of the signal flow through the latent feature space is provided for predictive models for automated driving.

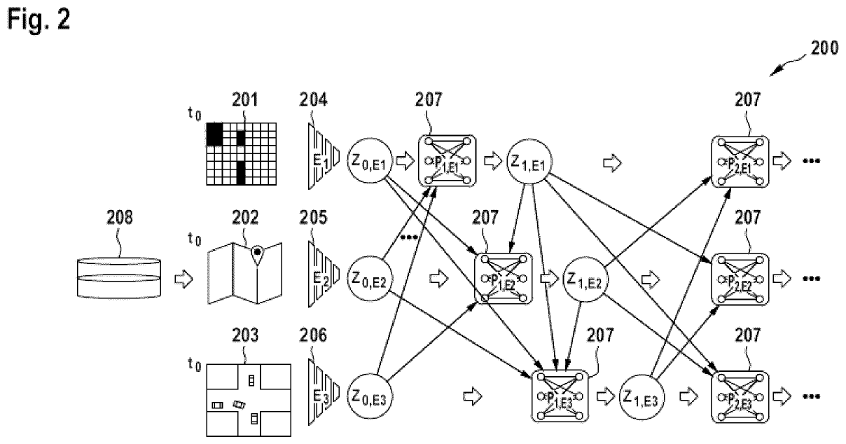

FIG. 2 illustrates a prediction model 200 with factorization, according to one embodiment.

The latent feature space on which the predictive components of the prediction model operate is divided into a latent space E1 for an occupancy grid 201, a latent space E2 for a digital (e.g., high-resolution (HD)) map 202, and a latent space E3 for an object list 203 that contains the agents (i.e., road users) present in the respective traffic scene.

For each of these latent spaces E1, E2, E3, the prediction model 200 contains a respective encoder 204, 205, 206 that encodes the occupancy grid 201, the digital map 202, and the object list 203 for an initial state (time index 0) of the ego vehicle's environment (i.e., a current state from which predictions are to be made) into a respective latent representation Z0,E1, Z0,E2, or Z0,E3. Accordingly, such a representation may also be considered encoding or embedding. The occupancy grid 201, the digital map 202, and the object list 203 are generated from input data from a scene dataset 208 (e.g., from sensor data, perception results (e.g., object detection), etc., e.g., the input data is perception results generated from sensor data).

The occupancy grid 201 is a right-angled grid with a predefined resolution, wherein each cell of the grid is associated with a value in the interval [0, 1]. For example, a value of 0.6 indicates with 60% confidence that the cell is occupied (by an object in the environment of the vehicle at a location corresponding to the cell).

The HD map 202 is a digital representation of the static elements of the environment of the vehicle (in a particular perimeter around the vehicle). For example, it contains the path of roads (e.g., roadway boundaries as polygons), information about traffic lights (and their state), relationships between roads, etc.

The object list 203 is a list of dynamic objects, i.e., agents (motor vehicles, bicycles, pedestrians, . . . ). For each agent, it contains, cartesian coordinates (e.g., a corner) of a bounding box around the agent, the orientation of the bounding box of the agent, the length, width, and height of the bounding box (or coordinates of multiple corners of the bounding box), values of dynamic parameters (at the respective time index), such as speed, acceleration, steering angle, etc., and optional values of further object parameters, e.g. maximum speed, etc.

For each latent representation Z0, E1, Z0, E2, and Z0, E3, the latent prediction model 200 contains a sequence of prediction networks 207:
P1, E1, P2, E1, . . . for the latent representation of the occupancy grid 201,
P1, E2, P2, E2, . . . for the latent representation of the HD map 202 and
P1, E3, P2, E3, . . . for the latent representation of the list of objects 203.

With these sequences of predictive networks, for each latent space E1, E2, E3 a respective multi-layered prediction is made for future occupancy grids, future HD maps and future object lists within the respective latent space, i.e., the representations of the future occupancy grids (Z1, E1, Z2, E1, . . . ), the future HD maps (Z1, E2, Z2, E2, . . . ) and future object lists (Z1, E3, Z2, E3, . . . ) are predicted.

Each prediction network 207 receives a latent representation in the respective latent space (based on the latent (initial) representation Z0, E1, Z0, E2 and Z0, E3 (also referred to as “first” occupancy grid representation, “first” map representation, and “first” object list representation, respectively)) for the occupancy grid and predicts it into the future so that it may determine a predicted (i.e., “second”, “third” etc.) Representations are generated in the respective latent space, e.g., Z1, E1 from Z0, E1, etc. Each predictive network 207 may also use the representations of previous time increments for other latent spaces, so (as shown by the arrows) P1, E2 uses Z0, E1 and Z0, E3 as input in addition to Z0, E2.

Latent representations of earlier increments may also be incorporated. For example, the predictive network P2, E3 receives not only the latent representations of the occupancy grid Z1, E1 and the HD map Z1, E2 for the previous time increment (time index 1), but also the latent (initial) representations of the occupancy grid Z0, E1 and the HD map Z0, E2. Such a supply of latent representations over several time increments is not shown in FIG. 2 for reasons of clarity.

In addition, the predictive networks for the HD map use the prediction of the occupancy grid representation from the same time increment. The predictive networks for the object list use the prediction of occupancy grid representation and the prediction of HD map representation from the same time increment. For example, P1, E2 receives as input not only the previous representation in the latent space to which it belongs (E2: latent space for the HD map), i.e., Z0, E2, but also the prediction Z1, E1 (i.e., the prediction with the same time index to which it belongs for the latent space for the occupancy grid, i.e., the “current” prediction).

To provide a clear example, there is a hierarchy between the occupancy grid 201, the digital map 202, and the object list 203: For each time increment, the prediction of the object list 203 incorporates the (current) prediction of the digital map 202 as well as the occupancy grid 201, and the prediction of the digital map 202 incorporates the (current) prediction of the occupancy grid 201. According to other embodiments, only a portion of these dependencies may also be present: For example, the prediction of the object list 203 incorporates the prediction of the digital map 202 but not that of the occupancy grid 201.

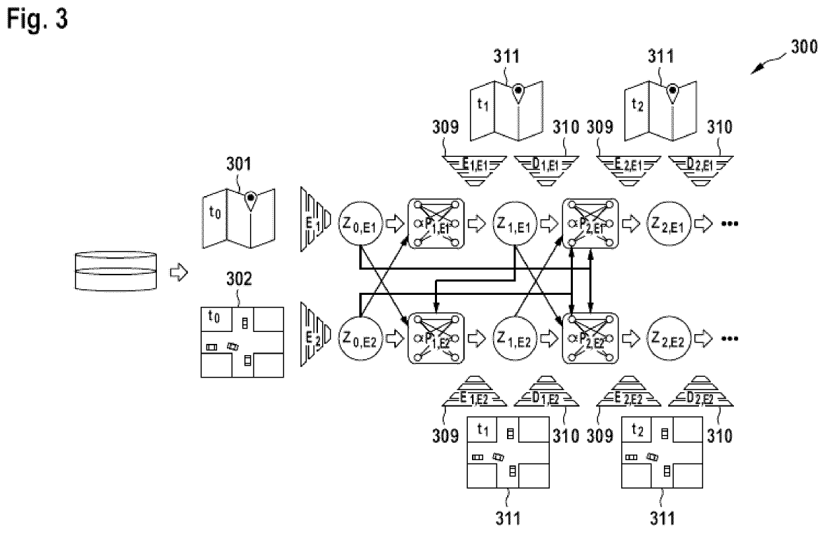

These dependencies (and the factorization) result in improved control (and ultimately improved planning and control) for the following reasons. Online mapping (i.e., determining/predicating a digital (HD) map) from measurement data benefits from predicted occupancy grids because static elements may be identified in the environment through the occupied space that potentially belong to elements in the map. The object list prediction benefits from previously predicted HD maps and future occupancy grids, as, for example, navigable and non-navigable space are identifiable using the occupancy grids and traffic rules are identifiable using the HD map. This leads to implausible incorrect predictions that do not comply with the rules or leave the navigable space becoming very unlikely. By factorizing the latent space in the occupancy grid, digital map (e.g. HD map) and object list modalities, it is possible to better examine the individual modalities using dedicated decoders (see FIG. 3). This improved interpretability is particularly useful in the case of automated driving to validate predictive functionality and to enable better failure identification in the event of damage. Factorization also makes it possible that, in the event of missing/insufficient sensor or perception data (e.g. by briefly increasing the latency in the system (e.g. components of the control device 102 and sensors) or due to failure of portions of the system) individual encoded latent modalities of the current state are replaced with pre-predicated latent states of the modality (if the distances between the prediction steps match the over-planning frequency (i.e., with the time intervals, in which inputs such as sensor data or perception results are expected)). A fault in individual sensors or perception components may thus be compensated for in a dedicated manner, whereas in the case of latent prediction without factorization, either all or no data may be replaced (including in comparison, that future decoded data like the occupancy grids will be encoded again and used as a replacement for the failure of the same modality, information loss occurs as compared to the factorized prediction, since typically only some of the possibilities (which contains the latent representation) are typically decoded during the decoding (mode-pruning)). This is particularly advantageous for automated driving as multiple sensors are often used, wherein each sensor has specific strengths, and individual sensor modalities may typically fail or provide poor results for short periods of time. Specifically, an occupancy grid may be determined particularly well from lidar or radar data. In contrast, elements of an HD map (road signs, traffic lights, road markings) may be determined particularly well from camera data. The factorization described above thus makes it possible, for example, to compensate for a failure of lidar or radar quickly using a previous latent occupancy grid prediction (shifted accordingly in the time index). A failure of the cameras, for example due to glare, may be compensated for in a dedicated manner by the latent map predictions.

FIG. 3 illustrates the training using additional encoders 309 or decoders 310.

To simplify the illustration, there are only two latent spaces E1 and E2 here that belong to a digital map 301 and an object list 302, respectively. In contrast to FIG. 2, however, the supply of predictions from time increments further in the past is also shown here, e.g. the supply from Z0,E1 to P2,E1.

For the training of the predictive model 300, according to one embodiment, one or more decoders 310 are trained, labeled as Di, wherein i is the time index, which re-transforms the predicted latent representation back into the corresponding “natural” representation (i.e., into a digital map or object list). By matching the transformation result with the (ground truth) data from a training dataset for the corresponding time increment (and a cost function (or “loss function”) in the natural space), a training signal (cost or “loss”) is thus generated, which is then reverse-propagated by the neural networks of the predictive model 300 and the predictive model 300 (i.e., the direction of its weights) is adjusted in the direction of decreasing costs.

All decoders 310 of a modality may match in architecture as well as weights. This reduces the training effort.

Alternatively, the calculation of the cost function may be performed in the latent space: Additional encoders 309, denoted with Ei (i once again stands for time index), may be trained, which allow the existing development of the scene to be transformed from natural ground truth data 311 present in the training dataset into its latent representations for the various time increments. These may then be compared to the predicted latent representations for the time increments for the training. However, all encoders of a modality (including encoder 301 or 302) for the initial representation may also match in their architecture as well as weights. This reduces the training effort.

It may also be provided that in each prediction step, an additional encoded SD (standard definition) map may be used as input for one or more of the prediction networks for the digital map for better HD map determination. This is typically a strong prior that improves online HD map generation.

The prediction model 200 may also be used for planning the behavior of an automated vehicle by predicting (planning) the behavior of the automated vehicle (ego vehicle) as the fourth modality analogous to FIG. 2. This modality is inserted into the hierarchy after the object list (i.e. predictions for other agents), i.e. the predictive networks for the modality use predictions for the object list and, if necessary, also for the digital map and the occupancy grid ((at least) for the same time index). The plausible object list prediction, as well as the more accurate and more plausible HD map prediction, ultimately enable a safer, compliant and appropriate behavior to be planned for the situation.

An additional visibility grid may also be encoded and predicated as an additional (e.g., fifth) modality. This would be used in the hierarchy of between the occupancy grid and the HD map (i.e., prediction networks for the visibility grid would ((at least) for the same time index) use predictions for the occupancy grid and its predictions would be used ((at least) for the same time index) by the prediction networks for the HD map). The visibility grid represents visible and non-visible areas for the quantity of sensors of the automated vehicle.

For example, the additional predicted visibility grid allows a safer behavior of the automated vehicle to be predicted (i.e., to be planned) as hazardous, non-visible areas may be explicitly considered.

For example, the visibility grid is a perpendicular grid with a predefined resolution in which a cell of the grid is assigned a value of 0 or 1:1 means that the cell is in the field of view for the ego vehicle, while 0 means that the cell is out of the field of view.

The training data (contained in the training dataset) includes a temporal sequence of the input data over a plurality of consecutive time increments. The training may be performed with any predictive loss functions (e.g., L1 or L2 loss).

A time increment of the prediction model 200, 300 may correspond to a single real (e.g., control) time increment or a segment of multiple time increments.

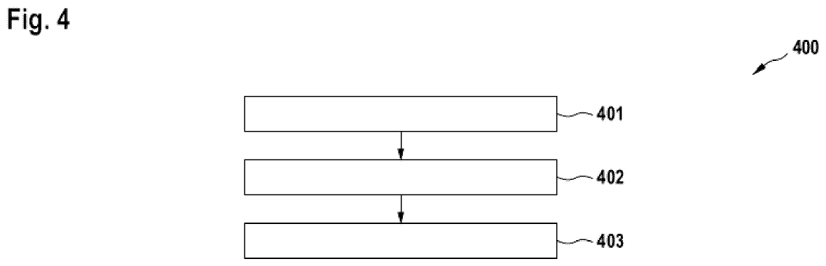

In summary, according to various embodiments, a method as shown in FIG. 4 is provided.

FIG. 4 shows a flowchart 400 depicting a method for predicting a state of the environment of a vehicle according to one embodiment.

The following are determined in 401 (from sensor data, e.g., by processing the sensor data for perception) an occupancy grid of the vehicle's environment for a current state of the vehicle's environment, a digital map for the current state of the vehicle's environment, and a list of objects present in the current state of the vehicle's environment

The following are encoded in 402 (by respective encoders, e.g., implemented through neural networks) the occupancy grid to a first occupancy grid representation in a latent space for the occupancy grid, the digital map to a first map representation in a latent space for the digital map, and the list of objects to a first object list representation in a latent space for the list of objects (the latent spaces may be different or the same).

The following are predicted in 403 (based on the first occupancy grid representation, the first map representation, and the first object list representation): for each of one or more points in time of future states of the vehicle's environment, a respective further occupancy grid representation in the latent space for the occupancy grid, a respective further map representation in the latent space for the map representations, and a respective object list representation in the latent space for the list of objects. For example, a sequence of further occupancy grid representations, a sequence of further map representations, and a sequence of further object list representations are predicted corresponding to a sequence of points in time.

During this prediction, for each of the one or more points in time, the further occupancy grid representation is predicted before predicting the further map representation and the further object list representation, and is used for predicting the further map representation and the further object list representation.

The method according to FIG. 4 may be performed by one or a plurality of computers comprising one or a plurality of data processing units. The term “data processing unit” may be understood to mean any type of entity that enables the processing of data or signals. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here may also be understood as a data processing unit or logic circuit array. One or a plurality of the method steps described in detail here may be carried out (e.g., implemented) by a data processing unit by means of one or a plurality of specific functions performed by the data processing unit.

According to various embodiments, the method is thus, in particular, computer-implemented.

The traffic situation may be captured by means of sensor data. Various embodiments may receive and use sensor data for this from various sensors, such as video, radar, LiDAR, ultrasound, motion, thermal imaging, etc.

The predicted trajectories may be used to control an ego vehicle (i.e., taking into account, for example, planning a trajectory of the ego vehicle such that, if the predicted trajectories are assumed to be correct, no collision should occur). The prediction model may be trained end-to-end, i.e., using example scenarios with future trajectories as ground truth for supervised learning.

What is claimed is:

1. A method for predicting a state of an environment of a vehicle, comprising:
determining an occupancy grid of the environment of the vehicle for a current state of the environment of the vehicle;
determining a digital map for the current state of the environment of the vehicle;
determining a list of objects present in the environment of the vehicle in the current state of the environment of the vehicle;
encoding the occupancy grid to a first occupancy grid representation in a latent space for the occupancy grid;
encoding the digital map to a first map representation in a latent space for the digital map;
encoding the list of objects to a first object list representation in a latent space for the list of objects; and
predicting, for each of one or more points in time of future states of the environment of the vehicle, (i) a respective further occupancy grid representation in the latent space for the occupancy grid, (ii) a respective further map representation in the latent space for the digital map, and (iii) a respective further object list representation in the latent space for the list of objects;
wherein, for each of the one or more points in time, the respective further occupancy grid representation is predicted prior to predicting the respective further map representation and predicting the respective further object list representation and the respective further occupancy grid representation is used for predicting the respective further map representation and predicting the respective further object list representation.

2. The method according to claim 1, wherein, for each of the one or more points in time, the prediction of the respective further map representation occurs prior to the prediction of the respective further object list representation and is used to predict the respective further object list representation.

3. The method according to claim 1, further comprising:
determining a visibility grid for the current state of the environment of the vehicle;
encoding the visibility grid to a first visibility grid representation in a latent space for the visibility grid; and
predicting, for each of the one or more points in time, a respective further visibility grid representation,
wherein, for each of the one or more points in time, the prediction of the respective further occupancy grid representation is performed prior to predicting the respective further visibility grid representation and is used for predicting the respective further visibility grid representation, and
wherein the prediction of the respective further visibility grid representation is performed prior to predicting the respective further map representation and is used for predicting the respective further map representation.

4. The method according to claim 1, further comprising:
planning a behavior of the vehicle for each of the one or more points in time by determining a respective behavior representation in a latent space for the behavior using the respective further occupancy grid representation, the respective further map representation, and the respective further object list representation predicted for the point in time.

5. The method according to claim 1, further comprising:
predicting the respective further occupancy grid representation using a neural occupancy grid predictive network;
predicting the respective further map representation using a neural map predictive network;
predicting the respective further object list representation using a neural object list predictive network; and
training the neural occupancy grid predictive network, the neural map predictive network, and the neural object list predictive network by:
determining occupancy grid costs by decoding the respective further occupancy grid representation to a corresponding respective further occupancy grid and comparing it to ground truth information for the occupancy grid for the respective point in time, and/or by encoding the ground truth information for the occupancy grid for the respective point in time to an occupancy grid ground truth and comparing it with the respective further occupancy grid representation;
determining map costs by decoding the respective further map representation to a corresponding respective further digital map and comparing it to a ground truth information for the digital map for the respective point in time, and/or by encoding the ground truth information for the digital map for the respective point in time to a map ground truth and comparing it to the further map representation; and/or
determining object list costs by decoding the respective further object list representation to a corresponding respective further list of objects for the respective point in time and comparing it with a ground truth information for the list of objects for the respective point in time and/or by encoding the ground truth information for the list of objects for the respective point in time to an object list ground truth and comparing it with the further object list representation.

6. The method according to claim 1, wherein a computer program includes instructions that, when executed by a processor, cause the processor to carry out the method.

7. A method for controlling a vehicle, comprising:
predicting a state of an environment of the vehicle according to the method of claim 1; and
controlling the vehicle based on the predicted state of the environment.

8. A vehicle control device configured to perform the method according to claim 1.

9. A non-transitory computer-readable medium that stores instructions that, when executed by a processor, cause the processor to carry out the method according to claim 1.
